(19) United States
(12) Patent Application Publication
(10) Pub. No.: US 2025/0337306 A1
(43) Pub. Date: Oct. 30, 2025

(54) SYNCHRONOUS ELECTRIC MACHINE FOR AIRCRAFT, ASSOCIATED PROPULSION DEVICE, TURBOSHAFT ENGINE AND METHOD

(71) Applicant: SAFRAN HELICOPTER ENGINES, Bordes (FR)

(72) Inventors: Thomas KLONOWSKI, MOISSY CRAMAYEL (FR); Sophie HUMBERT, MOISSY CRAMAYEL (FR); David LEMAY, MOISSY CRAMAYEL (FR); Alexandre Edouard Emile FIGIELSKI, MOISSY CRAMAYEL (FR)

(73) Assignee: SAFRAN HELICOPTER ENGINES, Bordes (FR)

(21) Appl. No.: 18/866,516

(22) PCT Filed: May 11, 2023
(86) PCT No.: PCT/EP2023/062669

§ 371 Date: Nov. 15, 2024

(30) Foreign Application Priority Data
May 17, 2022 (FR) 2204680

(51) Int. Cl. H02K 23/36; B64D 27/33; H02P 29/028

(52) U.S. Cl. CPC H02K 23/36; B64D 27/33; H02P 29/028; H02K 2213/06

(57) ABSTRACT

The invention relates to a synchronous electric machine for aircraft, which comprises a stator and a wound rotor inserted into the stator, the stator comprising two sets of stator coils intended to be connected to different power converters, and the wound rotor comprising a rotor shaft and two rotor coils each intended to be supplied with a different supply current.

The two sets of stator coils are arranged in the stator in such a way that when a first set of stator coils fails, the second set of stator coils cooperates with at least the second rotor coil supplied with the associated supply current in order to generate a mechanical torque on the rotor shaft, and so that the power converter connected to the first set of stator coils does not deliver any electrical power.

### TECHNICAL FIELD OF THE INVENTION

The invention relates to rotating electric machines for aircraft, and more particularly synchronous electric machines with a wound rotor for aircraft.

The invention further relates to a propulsion device and a propulsion system comprising such an electric machine, an aircraft comprising such a propulsion device or such a propulsion system, and a method for controlling such an electric machine.

### PRIOR ART

An aircraft, for example a twin-engine helicopter, of the vertical take-off and landing (VTOL) type, comprises a propulsion system comprising two turboshaft engines, each turboshaft engine comprising a gas generator and a free-turbine rotated by the gas generator and integral with an output shaft. The output shaft of each free-turbine is suitable for driving a power transmission box, which in turn drives the helicopter rotor blade. It is known that when the helicopter is in a cruising flight situation (i.e. when it is operating under normal conditions, during all phases of the flight, excluding transient take-off, climbing, landing or hovering phases), the turboshaft engines develop low powers which are less than the maximum continuous powers. These low power levels lead to a specific consumption (hereinafter, Cs), defined as being the ratio between the hourly fuel consumption by the combustion chamber of the turboshaft engine and the mechanical power supplied by this turboshaft engine, greater by of order 30% than the Cs of the maximum take-off power, and therefore an excess fuel consumption in cruising flight.

In order to reduce the helicopter's fuel consumption it is known, in a cruising flight situation, to place one of the two turbines on standby, so that the other engine operates at high speed and therefore benefits from a much lower Specific Consumption.

In order to overcome critical situations, in particular in the event of failure of the gas turbine which is not in standby or in the case of an avoidance manoeuvre, it is necessary to rapidly reactivate the turbine on standby.

Since this is a critical procedure, it is necessary to ensure a high level of reliability for the reactivation procedure of the turbine on standby, in order to guarantee flight safety of the helicopter.

Document FR3027058 discloses a helicopter comprising at least one turboshaft engine as described above, and a hybrid turboshaft engine comprising a turboshaft engine as described and a rapid reactivation system comprising two reactivation chains.

Each reactivation chain comprises a rotating electric machine and a power conversion device operating said machine.

The helicopter further comprises an electrical energy store and an on-board network supplying the power conversion devices.

Each electric machine enables the hybrid turboshaft engine to react rapidly when it is on standby.

The redundancy of the reactivation chains ensures a high level of reliability of the “rapid reactivation” function.

However, the redundancy of the reactivation chains increases the mass of the helicopter therefore reducing the payload of the helicopter, and increasing the bulk of the rapid reactivation system.

In addition, it is known to replace at least one turbomachine intended to produce the thrust for a conventional take-off and landing (CTOL) type aircraft by an electric motor driving a propeller or rotor blade in order to reduce the high fossil-fuel consumption, in particular of kerosene, of the aircraft.

In general, the electric motor comprises a rotor equipped with permanent magnets.

However, when the rotor is rotated by the propeller or rotor blade driven by an incident airflow (“windmilling”), the magnets generate an excitation flux in the motor, which can induce short-circuit currents in the static windings of the motor.

The short-circuit currents heat the motor and are capable of deteriorating the motor.

Moreover, when a stator winding fails, the excitation flux generated by the permanent magnets induces a current in the failed stator winding which can propagate the failure.

### DISCLOSURE OF THE INVENTION

The invention aims to overcome all or some of these disadvantages.

In view of the above, the object of the invention is a synchronous electric machine for aircraft, comprising a stator and a wound rotor inserted into the stator, the stator comprising two sets of stator coils intended to be connected to different power converters, and the wound rotor comprising a rotor shaft and two rotor coils intended to each be supplied with a different supply current.

The two sets of stator coils are arranged in the stator in such a way that when a first set of stator coils fails, the second set of stator coils cooperates with at least the second rotor coil supplied with the associated supply current in order to generate electrical energy at the terminals of the second set of stator coils or to generate a mechanical torque on the rotor shaft, and in such a way that the power converter connected to the first set of stator coils does not deliver any electrical power.

The failed first set of stator coils is no longer supplied with electrical power in order to prevent the propagation of a fault by inducing a short-circuit current in the failed set of stator coils of the converter in said machine and in the power converter connected to said failed set of coils.

Despite the failure of the first set of coils, the second set of coils ensures the operation of the machine so that it delivers, to its rotor shaft, a mechanical torque equal to the nominal operating torque of the electric machine or delivers an electrical power to its terminals equal to the nominal electrical power delivered by said machine enabling the reliability of operation of said electric machine to be increased.

Preferably the two rotor coils are arranged in series on the rotor shaft, the first set of stator coils and the second set of stator coils being arranged in the stator in such a way that the first rotor coil and the first set of stator coils form a first electromagnetic converter, and in such a way that the second rotor coil and the second set of stator coils form a second electromagnetic converter.

Advantageously, the rotor comprises two identical magnetic rotor half-masses extending in a longitudinal direction of the rotor and the stator comprises two identical magnetic stator half-masses extending in a longitudinal direction of the stator, each rotor coil being inserted into a different magnetic rotor half-mass and each set of stator coils being inserted into a different magnetic stator half-mass.

Preferably, the rotor comprises two sets of supply rings, each set being connected to a different rotor coil, and wherein the stator comprises two sets of brushes each supplying power to a different set of rings, each set of brushes being intended to be connected to one of the second power converters.

A propulsion device for aircraft is also proposed, comprising an electric machine as defined above, and a propulsion propeller connected to the rotor shaft.

A hybrid turboshaft engine for aircraft is also proposed, comprising an electric machine as defined above and a turboshaft engine comprising a gas free-turbine, the free-turbine also being connected to the rotor shaft of the electric machine.

An aircraft comprising a propulsion device is also proposed as defined above, or a hybrid turboshaft engine as defined above.

A method for controlling a synchronous electric machine for aircraft is also proposed, the electric machine comprising a stator and a wound rotor inserted into the stator, the stator comprising two sets of stator coils connected to different power converters, and the wound rotor comprising a rotor shaft and two rotor coils each supplied with a different supply current.

The method comprises a deactivation of the first failed set of stator coils by operating the power converter connected to said first set in such a way that said converter does not deliver any electrical power to said set of coils, an electrical supply of the second set of stator coils by the associated power converter, and at least one supply of the second coil with the associated supply current in order to generate a mechanical torque on the rotor shaft or to generate electrical energy at the terminals of the second set of stator coils.

Preferably, the rotor comprising two identical magnetic rotor half-masses extending in a longitudinal direction of the rotor, and the stator comprising two identical magnetic stator half-masses extending in a longitudinal direction of the stator, each rotor coil being inserted into a different magnetic rotor half-mass and each set of stator coils being inserted into a different magnetic stator half-mass, the method comprising the control of the current supplies in such a way that the amplitude of the current supplying the rotor coil of a rotor half-mass covering the first set of stator coils decreases, such that said control current is substantially zero when said rotor half-mass covers the entirety of the first set of stator coils, and such that the amplitude of said control current increases when said rotor half-mass uncovers the first set of stator coils, the effective value of the control current being non-zero.

Advantageously, each supply current is sinusoidal.

### BRIEF DESCRIPTION OF THE DRAWINGS

Other aims, features and advantages of the invention will appear upon reading the following description, given just as a non-limiting example, and made with reference to the appended drawings wherein:

FIG. 1 schematically illustrates a first example of an aircraft according to the invention;

FIG. 2 illustrates an electrical diagram of a first example of an electric machine according to the invention;

FIG. 3 schematically illustrates a cross-section of the first example of the electric machine according to the invention;

FIG. 4 illustrates an electrical diagram of a second example of an electric machine according to the invention;

FIG. 5 schematically illustrates a radial cross-section of the second example of the electric machine according to the invention,

FIG. 6 illustrates a schematic modelling of the second example of the electric machine according to the invention,

FIG. 7 schematically illustrates the evolution of the rotor currents of the second example of the electric machine according to the invention, and

FIG. 8 schematically illustrates a first example of an aircraft according to the invention.

### DETAILED DISCLOSURE OF AT LEAST ONE EMBODIMENT

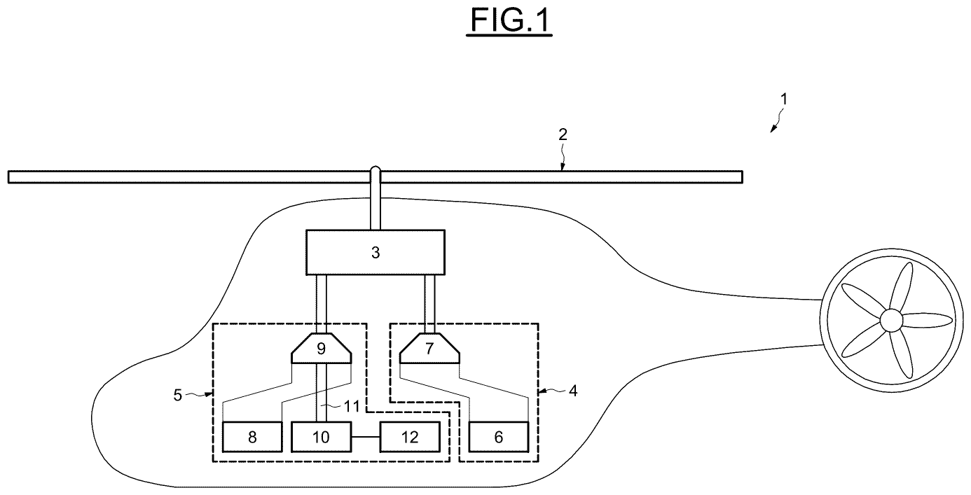

Referring to FIG. 1 which schematically illustrates an example of a twin-engine VTOL type aircraft 1 comprising a rotor blade 2, a gearbox 3, a turboshaft engine 4 and a hybrid turboshaft engine 5.

The turboshaft engine 4 and the hybrid turboshaft engine 5 drive the rotor blade 2 via the gearbox 3.

The turboshaft engine 4 comprises a gas generator 6 producing hot gas from the combustion of a fuel such as kerosene, and a free-turbine 7 connected to a first input of the gearbox 3.

The hot gases generated by the gas generator 6 drive the free-turbine 7 which in turn generates a mechanical torque driving the rotor blade 2.

The hybrid turboshaft engine 5 comprises a gas generator 8 producing hot gases from the combustion of a fuel such as kerosene, a free-turbine 9 connected to a first input of the gearbox 3, an electric machine 10 comprising a rotor shaft 11 connected to the free-turbine 9, and control means 12 of the machine 10.

The hot gases generated by the gas generator 8 drive the free-turbine 9 which in turn generates a mechanical torque driving the rotor blade 2.

The machine 10 can operate in a motor mode so as to deliver a driving mechanical torque in order to drive the free-turbine 9 or in a generator mode in such a way that the free-turbine 9 drives the rotor shaft 11 and the machine 10 produces electrical energy.

When the helicopter is in a cruising flight situation, the gas generator 8 of the hybrid turboshaft engine 5 is stopped in order to economise on fuel.

When a reactivation of the hybrid turboshaft engine 5 is necessary, for example during an avoidance manoeuvre of an obstacle in flight, or when the turbomachine 4 fails, the machine 10 drives the free-turbine 9 in order to facilitate the starting of the hybrid turboshaft engine 5.

The machine 10 is of the polyphase synchronous type with wound rotor.

It is assumed in the following that the machine 10 is three-phase.

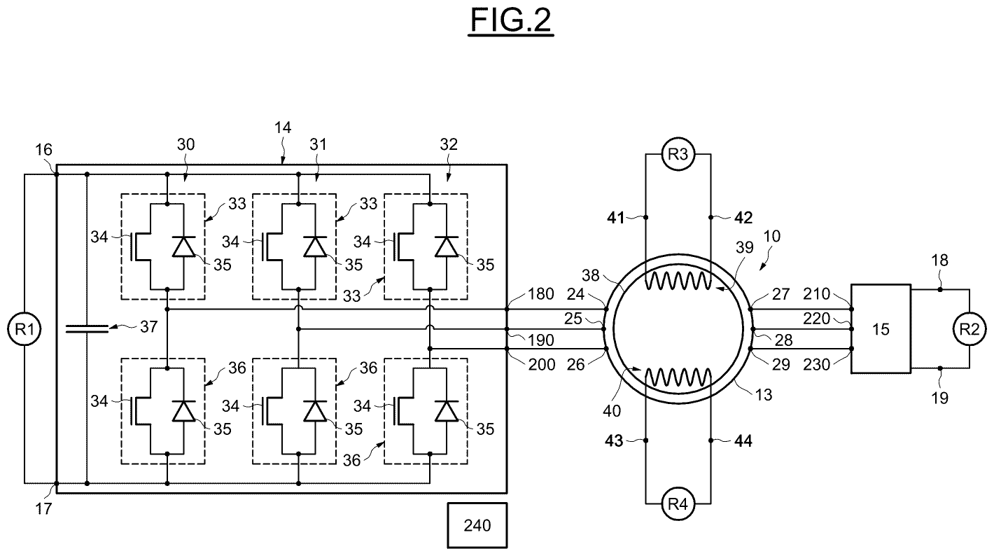

FIG. 2 shows an electrical diagram of a first example of the machine 10 and control means 12.

The machine 10 comprises a stator 13 comprising a first set of stator coils and a second set of stator coils (not shown in this figure).

The coils of the first set form a first set of three phases, for example star-coupled or delta-coupled, each phase comprising the same number of poles.

The coils of the second set form a second set of phases, for example star-coupled or delta-coupled, each phase comprising the same number of poles as the phases formed by the first set of coils.

Each set of coils is supplied by a different reversible power converter 14, 15.

Each converter 14, 15 comprises supply terminals 16, 17, 18, 19 and output terminals 180, 190, 200, 210, 220, 230.

The first converter 14 is connected to a first electrical supply network R1 of the helicopter, and the second converter 15 is connected to a second electrical supply network R2 of the helicopter.

The networks R1 and R2 are independent, so that if one of the networks fails, the other network is functional.

Each of the phases of the first set of three phases comprises a connection terminal 24, 25, 26 connected to a different output terminal 180, 190, 200 of a first power converter 14, and each of the phases of the second set of three phases comprises a connection terminal 27, 28, 29 connected to a different output terminal 210, 220, 230 of the second power converter 15.

Since the architecture of the converters 14, 15 is identical, only a first converter 14 supplying the first set of stator coils is described in detail.

The first converter 14 comprises as many switching arms 30, 31, 32 as phases of the machine 10.

Each switching arm 30, 31, 32 comprises a first switching cell 33 comprising for example a field-effect transistor 34 and a diode 35. The gate of the transistor 35 is controlled by operating means 240 comprising, for example, a controller.

The drain of the transistor 34 is connected to a first supply terminal 16 and to the cathode of the diode 35, the source of the transistor 34 is connected to the anode of the diode 35 and to an output terminal 180, 190, 200.

Each switching arm 30, 31, 32 further comprises a second switching cell 36 comprising, for example, the field-effect transistor 34 and the diode 35 arranged in such a way that the drain of the transistor 34 is connected to an output terminal 180, 190, 200 and to the cathode of the diode 35, and the source of the transistor 34 is connected to the anode of the diode 35 and to the second supply terminal 17.

The first converter 14 further comprises one or more filtering capacitors 37 extending between the supply terminals 16, 17.

The machine 10 further comprises a wound rotor 38 comprising two rotor coils 39, 40 comprising supply terminals 41, 42, 43, 44.

The supply terminals 41, 42 of a first rotor coil 39 are connected to a third electrical supply network R3, and the supply terminals 43, 44 of the second rotor coil 40 are connected to a fourth electrical supply network R4.

The networks R3 and R4 are independent, so that if one of the networks fails, the other network is operational.

The first set of stator coils, the second set of stator coils, the first rotor coil 38 and the second rotor coil 40 are arranged in the machine 10 in such a way that the first set of stator coils and the first rotor coil 39 cooperate to deliver a mechanical torque on the rotor shaft 11 or to deliver an electrical power on the connection terminals 24, 25, 26, and in such a way that the second set of stator coils and the second rotor coil 40 cooperate to deliver a mechanical torque on the rotor shaft 11 or to deliver an electrical power on the connection terminals 27, 28, 29.

The control means 12 comprise the first and second converters 14, 15 and the operating means 240.

The operating means 240 are produced, for example, from a controller.

The first set of stator coils and the first rotor coil 39 form a first electromagnetic converter 45 (not shown), and the second set of stator coils and the second rotor coil 40 form a second electromagnetic converter 46 (not shown), independent of the first electromagnetic converter.

The operating means 240 operate the power converters 14, 15 in such a way that when one of the first and second electromagnetic power converters fails, the power converter 14, 15 connected to the set of stator coils of said failed converter does not deliver any electrical power and in such a way that the other electromagnetic converter is functional in order to generate a mechanical torque or to generate electrical energy at the terminals of the set of stator coils of the functional electromagnetic converter.

In addition, the operating means 240 deactivate the supply of the rotor coil of the failed converter in order to de-excite the rotor of the failed converter so as to prevent the propagation of the fault by inducing a short-circuit current in the set of stator coils of the failed converter.

The stator coils and the rotor coil of the functional electromagnetic converter are supplied despite the failure of the other electromagnetic converter.

Each electromagnetic converter 45, 46 is sized so as to ensure a rapid reactivation of the hybrid turboshaft engine 5 increasing the reliability of the reactivation function.

Since the networks R1, R2, R3 and R4 are all independent, the reliability of the reactivation function is improved.

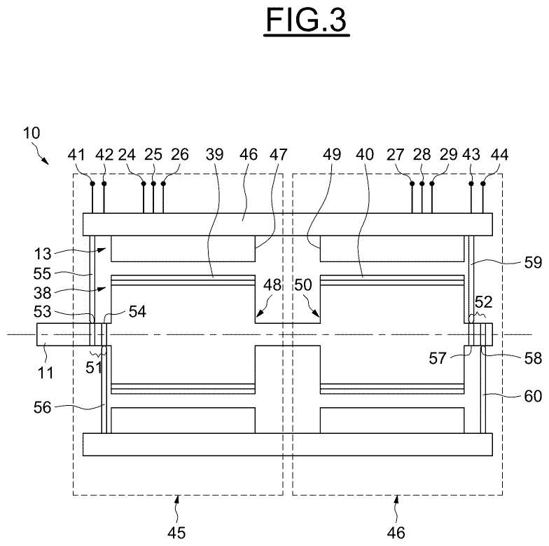

FIG. 3 schematically illustrates a cross-section through the machine 10 according to the first example.

The machine 10 comprises a casing 46 housing the electromagnetic converters 45, 46.

The first electromagnetic converter 45 comprises the first set of stator coils 47 connected to the connection terminals 24, 25, 26, a magnetic mass 48 surrounding the rotor shaft 11 and housing the first rotor coil 39.

The second electromagnetic converter 46 comprises the second set of stator coils 49 connected to the connection terminals 27, 28, 29, a magnetic mass 50 surrounding the rotor shaft 11 and housing the second rotor coil 40.

The magnetic masses 48, 50 of the electromagnetic converters 45, 46 are mounted in series on the rotor shaft 11.

The sets of stator coils 47, 49 form the stator 13, and the rotor shaft 11 and the magnetic masses 48, 50 comprising the rotor coils 39, 40 form the rotor 38.

The rotor 38 further comprises two sets of supply rings 51, 52.

A first set of conductive rings 51 comprises two rings 53, 54 arranged on the rotor shaft 11 and connected to the first rotor coil 39.

Each ring 53, 54 cooperates with a different brush 55, 56 of a first set of brushes of the stator 13.

The brushes 55, 56 are connected to the supply terminals 41, 42 in order to supply the first rotor coil 39.

The second set of rings 52 comprises two rings 57, 58 arranged on the rotor shaft 11 and connected to the second rotor coil 40.

Each ring 57, 58 cooperates with a different brush 59, 60 of a second set of brushes of the stator 13.

The brushes 59, 60 are connected to the supply terminals 43, 44 in order to supply the second rotor coil 40.

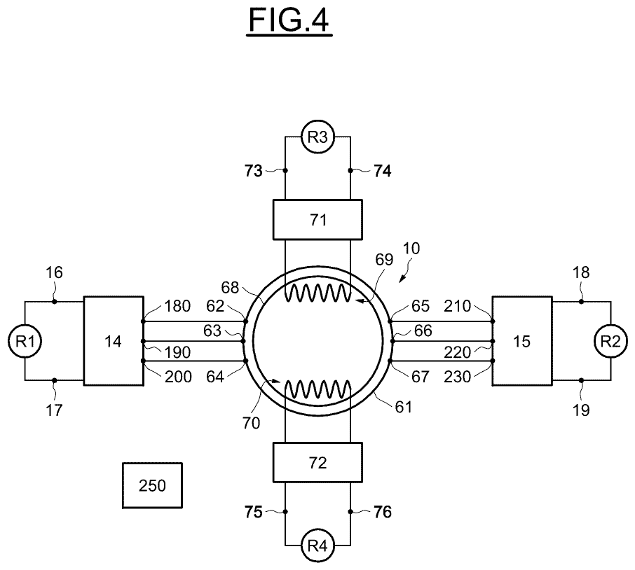

FIG. 4 shows an electrical diagram of a second example of the machine 10 and the control means 12.

It shows the first and second power converters 14, 15.

The machine 10 comprises a stator 61 comprising a first set of stator coils and a second set of stator coils (not shown in this figure).

The coils of the first set of stator coils form three first phases, for example star-coupled or delta-coupled, each phase comprising a same number of poles.

The coils of the second set of stator coils form three second phases, for example star-coupled or delta-coupled, each phase comprising the same number of poles as the phases formed by the first set of coils.

Each set of coils is supplied by a different reversible power converter 14, 15.

The output terminals 180, 190, 200 of a first converter 14 are each connected to a connection terminal 62, 63, 64 of a different first phase, and the output terminals 210, 220, 230 of the second converter 15 are each connected to a connection terminal 65, 66, 67 of a different second phase.

The machine 10 further comprises a wound rotor 68 comprising two rotor coils 69, 70 each independently supplied by auxiliary power converters 71, 72.

The auxiliary power converters 71, 72 are produced from switching cells 30, 31 and comprise input terminals 73, 74, 75, 76.

The supply terminals 73, 74 of a first auxiliary power converter 71 are connected to the third network R3 and the supply terminals 75, 76 of a second auxiliary power converter 72 are connected to the fourth network R4.

The control means 12 comprise the first and second converters 14, 15, the first and second auxiliary converters 71, 72, and operating means 250 operating the gate of the transistors of the first and second converters 14, 15 and of the first and second auxiliary converters 71, 72 in such a way that the machine 10 delivers a mechanical torque on the rotor shaft 11 or generates an electrical power at its terminals.

The operating means 250 are produced, for example, from a controller.

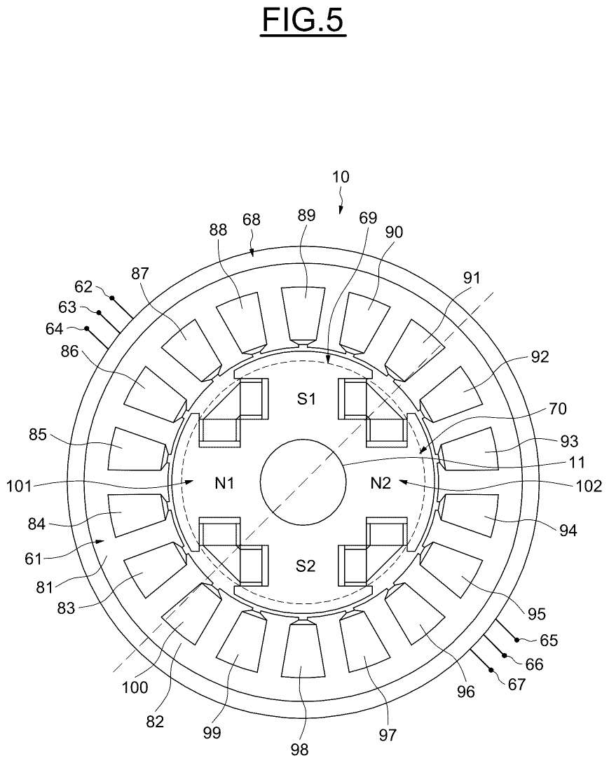

FIG. 5 schematically illustrates a radial cross-section of the second example of the machine 10.

The machine 10 comprises a casing 80 in which the stator 61 and the rotor 68 are housed.

The stator 61 comprises two identical magnetic stator half-masses 81, 82 extending in a longitudinal direction of the stator 61, and connected together to form the stator 61.

The first set of stator coils is inserted into a first magnetic stator half-mass 81 and comprises nine coils 83 to 91 inserted between the stator teeth of said stator half-mass, extending in a longitudinal direction of the stator and forming three poles per phase.

A first phase of the first stator half-mass 81 comprises the coils 83, 86 and 89 and is supplied by the connection terminal 62, a second phase of the first stator half-mass 81 comprises the coils 84, 87 and 90 and is supplied by the connection terminal 63, and the third phase of the first stator half-mass 81 comprises the coils 85, 88 and 81 and is supplied by the connection terminal 64.

The second set of stator coils is inserted into a second magnetic stator half-mass 82 and comprises nine coils 92 to 100 inserted between the stator teeth of said stator half-mass, extending in a longitudinal direction of the stator and forming three poles per phase.

A first phase of the second stator half-mass 82 comprises the coils 92, 95, 98 and is supplied by the connection terminal 65, a second phase of the second stator half-mass 82 comprises the coils 93, 96 and 99 and is supplied by the connection terminal 66, and the third phase of the second stator half-mass 82 comprises the coils 94, 97, 100 and is supplied by the connection terminal 67.

The windings of the stator half-masses 81, 82 are distributed, enabling the torque distribution in the machine 10 to be optimised by attenuating the variations in torque.

In an alternative, the windings of the stator half-masses 81, 82 are concentric.

Of course, the first and second sets of stator coils can comprise more than three phases, each phase being able to comprise more than three poles.

Each pole can, in addition, be formed by a plurality of stator coils.

The rotor 68 comprises two identical magnetic rotor half-masses 101, 102, extending in a longitudinal direction of the rotor, and fixed on the rotor shaft 11 and between them in order to form the rotor 68.

A first magnetic rotor half-mass 101 comprises the first rotor coil 69 wound around rotor pads of the half-mass 101.

The rotor pads are arranged in the half-mass 101 so that they are perpendicular.

The turns of the coil 69 arranged on a first pad forming a North pole denoted N1 and the turns arranged on the second pad forming a South pole denoted S1 of the first coil 69, are arranged perpendicularly with respect to one another.

The second magnetic rotor half-mass 102 comprises the second rotor coil 70 wound around rotor pads of the half-mass 102.

The rotor pads are arranged in the half-mass 102 so that they are perpendicular.

The turns of the coil 70 arranged on a first plot forming a North pole denoted N2 and the turns arranged on the second pad forming a South pole denoted S2 of the first coil 70, are arranged perpendicularly with respect to one another.

The poles N1, S1, N2, S2 are arranged perpendicularly with respect to one another in the doubly wound rotor 68.

The machine 10 further comprises the first and second sets of rings 51, 52 (not shown in this figure) arranged on the rotor shaft 11 and cooperating with the brushes 55, 56, 59, 60 (not shown in this figure) in such a way that the first set of rings 51 supply the first coil 69 from the first auxiliary converter 71, and in such a way that the second set of rings 52 supply the second coil 70 from the second auxiliary converter 72.

When the two sets of stator windings are functional, the operating means 250 operate the auxiliary converters 71, 72 so that they each deliver a continuous supply current, and also operate the power converters 14, 15 in such a way that the machine 10 delivers a mechanical torque on the rotor shaft 11 or generates an electrical power at its terminals 61 to 67, re-injected by the converters 14, 15 into the networks R1, R2 of the helicopter.

When one of the first and second sets of stator windings fails, the operating means 250 operate the power converter 14, 15 connected to said failed set of stator coils in such a way that said converter no longer supplies said failed set and also operates the auxiliary converters 71, 72 in such a way that the amplitude of the current supplying the rotor coil 69, 70 of a rotor half-mass covering the failed set of stator coils decreases, in such a way that said control current is substantially zero when said rotor half-mass covers the entirety of the failed set of stator coils, and in such a way that the amplitude of said control current increases when said rotor half-mass uncovers the failed set of stator coils.

The effective value of the control current is non-zero.

The instantaneous value of the magnetic field created in the air gap of the machine 10 between the failed set of stator coils and the rotor coils is minimal, thus preventing the propagation of the failure to the functional set of stator coils.

In order to prevent the appearance of an excessively large parasite short-circuit current in the failed set of stator coils induced by the magnetisation of the air gap by the rotor winding opposite that facing the failed set of stator windings, dead-times can be created.

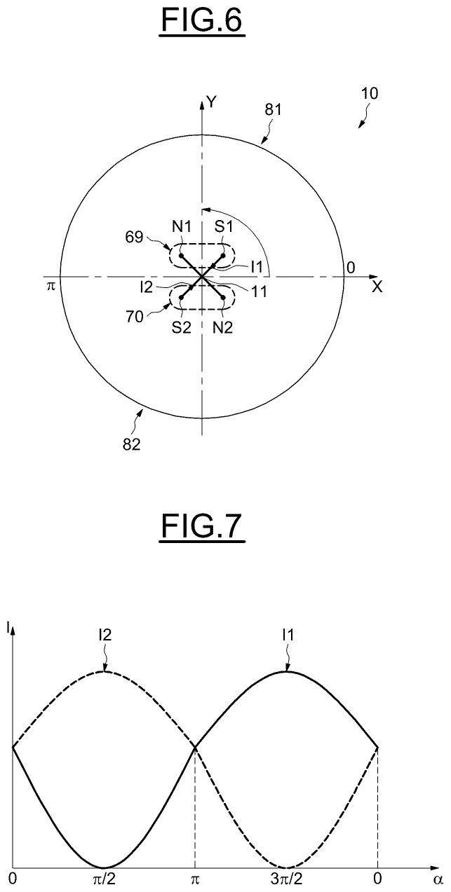

FIG. 6 illustrates a schematic modelling of the second example of the machine 10 illustrated in the FIG. 5.

The two identical magnetic stator half-masses 81, 82 and two rotor coils 69, 70 are respectively supplied with supply current I1 and supply current I2.

A reference frame is defined comprising an origin situated at the centre of the rotor shaft 11, a first fixed axis X and a second axis Y passing through the centre of the rotor coils 69, 70 and defining an angle α with the first axe X.

It is assumed that the first stator half-mass 81 extends from 0 to π along the first axe X, and the second stator half-mass 82 extends from π to 0 along the first axis X.

FIG. 7 illustrates the change over time of the sinusoidal supply currents I1, I2 delivered by the power auxiliary converters when the first set of stator coils incorporated in the first half-mass 81 fails.

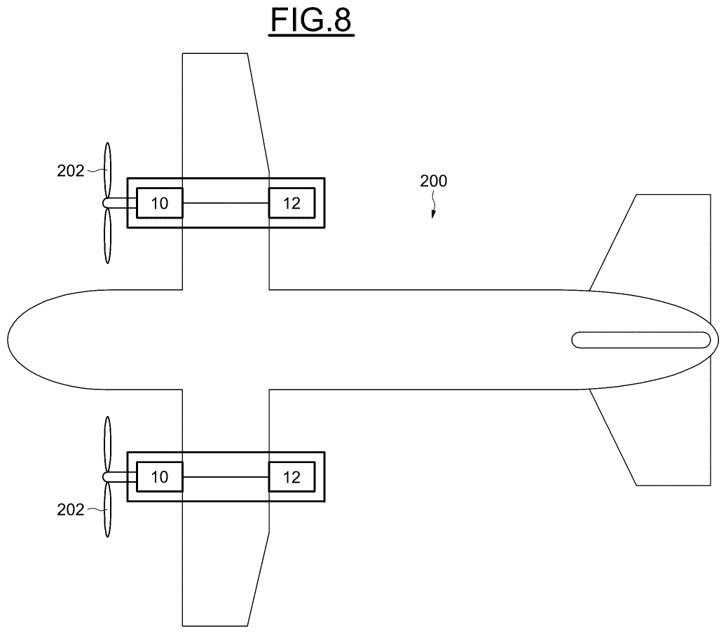

FIG. 8 illustrates an example of an aircraft 200 of the CTOL type, for example a twin-motor aeroplane comprising two identical propulsion devices 201 arranged on either side of a longitudinal axis of the aeroplane.

Each propulsion device 201 comprises a propeller 202 and a machine 10 as described above in FIGS. 2 to 5, and the control means 12 connected to the machine 10.

The rotor shaft 11 is connected to the propeller 10 in such a way that the propeller that is rotated by the motor 10 propels the aeroplane.

1. A synchronous electric machine for aircraft, comprising:
a stator having two sets of stator coils configured to connect to different power converters; and
a wound rotor inserted into the stator, the wound rotor having a rotor shaft and two rotor coils each intended to be supplied with a different supply current,
wherein the two sets of stator coils are arranged in the stator in such a way that:
when a first set of stator coils fails, the second set of stator coils cooperates with at least the second rotor coil supplied with the associated supply current in order to generate electrical energy at the terminals of the second set of stator coils or to generate a mechanical torque on the rotor shaft, and
the power converter connected to the first set of stator coils does not deliver any electrical power.

2. The electric machine according to claim 1, wherein the two rotor coils are arranged in series on the rotor shaft, and wherein the first set of stator coils and the second set of stator coils are arranged in the stator in such a way that:
the first rotor coil and the first set of stator coils form a first electromagnetic converter, and
the second rotor coil and the second set of stator coils form a second electromagnetic converter.

3. The electric machine according to claim 1, wherein the rotor comprises two identical magnetic rotor half-masses extending in a longitudinal direction of the rotor, and the stator comprises two identical magnetic stator half-masses extending in a longitudinal direction of the stator, and wherein each rotor coil are inserted into a different magnetic rotor half-mass and each set of stator coils are inserted into a different magnetic stator half-mass.

4. The electric machine according to claim 1, wherein the rotor comprises two sets of supply rings, each set being connected to a different rotor coil, wherein the stator comprises two sets of brushes each supplying power to a different set of rings, and wherein each set of brushes are intended to be connected to one of the second power converters.

5. A propulsion device for aircraft comprising:
an electric machine according to claim 1; and
a propulsion propeller connected to the rotor shaft.

6. A hybrid turboshaft engine for aircraft, comprising:
an electric machine according to claim 1; and
a turboshaft engine comprising a gas free-turbine, the free-turbine being additionally connected to the rotor shaft of the electric machine.

7. An aircraft comprising a propulsion device according to claim 5.

8. A method for controlling a synchronous electric machine for aircraft, the electric machine comprising a stator having two sets of stator coils configured to connect to different power converters, and a wound rotor inserted into the stator, the wound rotor comprising a rotor shaft and two rotor coils each supplied with a different supply current,
the method comprising:
deactivating the failed first set of stator coils by operating the power converter connected to the first set in such a way that the converter does not deliver any electrical power to the set of coils;
supplying the second set of stator coils with electricity from the associated power converter; and
supplying the second rotor coil with at least one associated supply current to generate a mechanical torque on the rotor shaft or to generate electrical energy at the terminals of the second set of stator coils.

9. The method according to claim 8, wherein the rotor further comprises two identical magnetic rotor half-masses extending in a longitudinal direction of the rotor, and wherein the stator further comprises two identical magnetic stator half-masses extending in a longitudinal direction of the stator, each rotor coil being inserted into a different magnetic rotor half-mass and each set of stator coils being inserted into a different magnetic stator half-mass, the method further comprising:
controlling the current supplies in such a way that the amplitude of the current supplying the rotor coil of a rotor half-mass covering the first set of stator coils decreases, such that the control current is substantially zero when the rotor half-mass covers the entirety of the first set of stator coils, and such that the amplitude of the control current increases when the rotor half-mass uncovers the first set of stator coils, the effective value of the control current being non-zero.

10. The method according to claim 9, wherein each supply current is sinusoidal.

11. An aircraft comprising a hybrid turboshaft engine according to claim 6.
